(19) United States
(12) Patent Application Publication
(10) Pub. No.: US 2026/0049241 A1
(43) Pub. Date: Feb. 19, 2026

(54) HIGHLY CONCENTRATED PARTICULATE POLYMER FRICTION-REDUCING SLURRY COMPOSITIONS AND FRACTURING FLUIDS MADE THEREFROM AND METHODS FOR MAKING AND USING SAME

(71) Applicant: PfP Industries, LLC, Houston, TX (US)

(72) Inventors: Asoke Kumar DEYSARKAR, Houston, TX (US); Nikhil PATEL, Houston, TX (US); Madhukar CHETTY, Houston, TX (US); Christopher E. DILLEY, Fulshear, TX (US)

(73) Assignee: PfP Industries, LLC, Houston, TX (US)

(21) Appl. No.: 19/297,217

(22) Filed: Aug. 12, 2025

Related U.S. Application Data
(60) Provisional application No. 63/683,928, filed on Aug. 16, 2024.

(51) Int. Cl. C09K 8/60; C09K 8/035; C09K 8/584; C09K 8/80; C09K 8/82

(52) U.S. Cl. CPC C09K 8/604; C09K 8/035; C09K 8/584; C09K 8/80; C09K 8/82; C09K 2208/28

(57) ABSTRACT

A highly concentrated particulate friction-reducing polymer slurry (HCPFRPS) composition includes an oil-based carrier composition and a particulate friction-reducing polymer composition. The oil-based carrier composition is present in an amount between about 50 wt. % and about 20 wt. %, and the particulate friction-reducing polymer composition is present in an amount between about 50 wt. % and about 80 wt. %.

### FIELD OF THE DISCLOSURE

Embodiments of the present disclosure relate to highly concentrated particulate friction-reducing polymer slurry compositions, fracturing fluids made therefrom, and methods for making and using same.

In particular, embodiments of the present disclosure highly concentrated particulate friction-reducing polymer slurry (HCPFRPS) compositions, fracturing fluids made therefrom, and methods for making and using same, wherein the HCPFRPS compositions including one or more solvents, one or more suspending agents, one or more suspending aids, one or more viscosity modifying agents, one or more surfactants, and one or more particulate friction-reducing polymers.

### BACKGROUND

Fluids to treat downhole formations to increase oil and gas production are commonly used today and are commonplace in most oil producing fields as are friction-reducing polymer compositions. There are many different fluid formulations that have been used to stimulate oil and/or gas production as well as many different friction-reducing polymer compositions used to reduce the friction of downhole fluids as they are pumped through drilling strings or treating mechanisms.

While many friction-reducing polymer compositions or systems have been formulated, there is still and continues to be a need in the art for additional friction-reducing polymer compositions or systems, especially very highly concentrated friction-reducing polymer slurries.

### SUMMARY OF THE DISCLOSURE

### Slurry Compositions

Embodiments of the present disclosure provide highly concentrated particulate friction-reducing polymer slurry (HCPFRPS) compositions including one or more solvents, one or more suspending agents, one or more suspending aids, one or more viscosity modifying agents, one or more surfactants, and one or more particulate friction-reducing polymers. The one or more solvents include one or more mineral oils, other similar petroleum alkane products, or mixtures thereof. The one or more suspending agents include one or more hydrophobic/organophilic particulate solid suspending agents, one or more polymeric suspending agents, or mixtures thereof. The one or more suspending aids include one or more amide compounds, one or more urea-containing compounds, one or more carbamate-containing compounds, or mixtures thereof. The one or more viscosity modifying agents include one or more amphiphilic viscosity modifying agents, one or more zwitterionic viscosity modifying agents, one or more polymeric viscosity modifying agents, or mixtures thereof. The one or more surfactants include one or more cationic surfactants, one or more anionic surfactants, one or more zwitterionic surfactants, one or more non-ionic surfactants, or mixtures thereof. The one or more particulate friction-reducing polymers include one or more acrylamide homopolymers (neutral, anionic, cationic, and/or zwitterionic), one or more acrylamide containing polymers, or mixtures thereof.

### Downhole Fluid Compositions

Embodiments of the present disclosure provide downhole fluid compositions including: (a) an effective amount of a HCPFRPS composition including one or more solvents, one or more suspending agents, one or more suspending aids, one or more viscosity modifying agents, one or more surfactants, and one or more particulate friction-reducing polymers, (b) a downhole base fluid, and (c) one or more downhole fluid additives.

The downhole fluids may comprise drilling fluid compositions, treating fluid compositions, completion fluid compositions, zone isolation fluids, or any combination thereof. The treating fluid compositions may comprise fracturing fluid compositions, stimulating fluid compositions, or any combination thereof.

In certain embodiments, the downhole fluid comprises a drilling fluid composition, the drilling fluid includes: (a) an effective amount of a HCPFRPS composition of this disclosure, (b) a drilling base fluid, and (c) one or more drilling fluid additives.

In certain embodiments, the downhole fluid comprises a treating fluid composition, the treating fluid includes: (a) an effective amount of a HCPFRPS composition of this disclosure, (b) a treating base fluid, and (c) one or more treating fluid additives.

In certain embodiments, the treating fluid comprises a fracturing fluid composition, the fracturing fluid includes: (a) an effective amount of a HCPFRPS composition of this disclosure, (b) a fracturing base fluid, and (c) one or more fracturing fluid additives.

In certain embodiments, the treating fluid comprises a stimulating fluid composition, the stimulating fluid includes: (a) an effective amount of a HCPFRPS composition of this disclosure, (b) a stimulating base fluid, and (c) one or more stimulating fluid additives.

In certain embodiments, the downhole fluid comprises a completion fluid composition, the completion fluid includes: (a) an effective amount of a HCPFRPS composition of this disclosure, (b) a completion base fluid, and (c) one or more completion fluid additives.

In certain embodiments, the downhole fluid comprises a zone isolation fluid composition, the zone isolation fluid includes: (a) an effective amount of a HCPFRPS composition of this disclosure, (b) a zone isolation base fluid, and (c) one or more zone isolation fluid additives.

### Methods of Making the Slurry Compositions

Embodiments of the present disclosure provide methods of making the HCPFRPS compositions of this disclosure including adding with mixing one or more solvents, one or more suspending agents, one or more suspending aids, one or more viscosity modifying agents, one or more surfactants, and one or more particulate friction-reducing polymers according to an addition protocol including an addition order and a mixing protocol including under mixing conditions of adding/mixing times, adding/mixing temperatures, adding/mixing pressures, and mixing speeds to form the HCPFRPS compositions.

### Methods of Making the Downhole Fluid Compositions

Downhole Fluid Compositions

Embodiments of the present disclosure provide methods of making downhole fluid compositions of this disclosure including adding with mixing: (a) an effective amount of a HCPFRPS composition of this disclosure, (b) a downhole base fluid, and (c) downhole fluid additives according to an addition protocol including an addition order and a mixing protocol including under mixing conditions of adding/mixing times, adding/mixing temperatures, adding/mixing pressures, and mixing speeds to form the downhole fluid compositions.

### Drilling Fluid Compositions

Embodiments of the present disclosure provide methods of making drilling fluid compositions of this disclosure including adding with mixing: (a) an effective amount of a HCPFRPS composition of this disclosure, (b) a drilling base fluid, and (c) drilling fluid additives according to an addition protocol including an addition order and a mixing protocol including under mixing conditions of adding/mixing times, adding/mixing temperatures, adding/mixing pressures, and mixing speeds to form the drilling fluid compositions.

### Proppant-Free Treating Fluid Compositions

Embodiments of the present disclosure provide methods of making proppant-free treating fluid compositions of this disclosure including adding with mixing: (a) an effective amount of a HCPFRPS composition of this disclosure, (b) a treating base fluid, and (c) treating fluid additives according to an addition protocol including an addition order and a mixing protocol including under mixing conditions of adding/mixing times, adding/mixing temperatures, adding/mixing pressures, and mixing speeds to form the proppant-free treating fluid compositions.

### Proppant-Containing Treating Fluid Compositions

Embodiments of the present disclosure provide methods of making proppant-containing treating fluid compositions of this disclosure including adding with mixing: (a) an effective amount of a HCPFRPS composition of this disclosure, (b) a treating base fluid, (c) treating fluid additives, and (d) one or more proppants according to an addition protocol including an addition order and a mixing protocol including under mixing conditions of adding/mixing times, adding/mixing temperatures, adding/mixing pressures, and mixing speeds to form the proppant-containing treating fluid compositions.

### Methods of Using the HCFRPS Compositions

Drilling Fluid Compositions

Embodiments of the present disclosure provide methods of drilling an oil and/or gas well comprising: (1) while drilling a borehole towards and into an oil/gas producing formation, circulating a drilling fluid composition, the drilling fluid composition including: (a) an effective amount of a HCPFRPS composition of this disclosure, (b) a drilling base fluid, and (c) one or more drilling fluid additives; (2) continuing drilling until the drilling penetrates the oil/gas producing formation; and (3) completing the drilling operation in the oil/gas producing formation.

### Treating Fluid Compositions

Embodiments of the present disclosure provide methods of treating an oil/gas producing formation including: (1) delivering or injecting a treating fluid composition into the oil/gas producing formation under treating conditions, the treating composition including: (a) an effective amount of a HCPFRPS composition of this disclosure, (b) a treating base fluid, and (c) one or more treating fluid additives; and (2) ceasing the infecting after the oil/gas producing formation has been sufficiently treated; and (3) bringing the oil/gas producing formation back onto production.

Alternatively, the methods may include: (1) hydrating the HCPFRPS composition in the base treating fluid; (2) adding the one or more treating fluid additives to form the treating fluid composition of this disclosure; (3) delivering or injecting the treating fluid composition into an oil/gas producing formation under treating conditions; (4) ceasing the delivering or infecting after the oil/gas producing formation has been sufficiently treated; and (5) bringing the oil/gas producing formation back onto production.

Embodiments of the present disclosure provide methods of treating an oil/gas producing formation including: (1) forming a proppant carrier fluid including: (a) an effective amount of a HCPFRPS composition of this disclosure, (b) a treating base fluid, (c) one or more treating fluid additives, and (d) one or more proppants; (2) delivering or injecting the proppant carrier fluid into an oil/gas producing formation under fracturing conditions; (4) ceasing the delivering or infecting after the oil/gas producing formation has been sufficiently fractured; and (5) bringing the oil/gas producing formation back onto production.

### Two Step

Embodiments of the present disclosure provide methods of treating an oil/gas producing formation including: (1) forming a first treating fluid excluding one or more proppants, (2) delivering or injecting the first treating fluid into a subterranean formation under fracturing conditions, (3) forming a second treating fluid including one or more proppants, and (4) delivering or injecting the second treating fluid into the subterranean formation under fracturing conditions. The two treating fluids may include the same or different fluid components; provided at least one of the treating fluids comprises one or more proppants.

Alternatively, the methods of treating an oil/gas producing formation may include: (1) forming a first polymer composition excluding one or more proppants, (2) hydrating the polymer composition in a first water composition to form a first fracturing fluid, (3) delivering or injecting the first fracturing fluid into a subterranean formation under fracturing conditions, (4) forming a second polymer composition including one or more proppants, (5) hydrating the second polymer composition and the one or more proppants in a water composition to form a second fracturing fluid, and (6) delivering or injecting the second fracturing fluid into the subterranean formation under fracturing conditions.

### DEFINITIONS USED IN THE DISCLOSURE

The term “at least one” means one or more or one or a plurality, additionally, these three terms may be used interchangeably within this application. For example, at least one device means one or more devices or one device and a plurality of devices.

The term “one or a plurality” means one item or a plurality of items.

The term “about” means that a value of a given quantity is within +10% of the stated value. In other embodiments, the value is within +5% of the stated value. In other embodiments, the value is within +2.5% of the stated value. In other embodiments, the value is within +1% of the stated value.

The term “substantially” or “essentially” means that a value of a given quantity is within ±5% of the stated value. In other embodiments, the value is within +2.5% of the stated value. In other embodiments, the value is within +2% of the stated value. In other embodiments, the value is within ±1% of the stated value.

In other embodiments, the value is within ±0.5% of the stated value. In other embodiments, the value is within ±0.1% of the stated value.

In this disclosure, every range of values (e.g., “from about x to about y” or “from approximately x to y” or “from approximately x-y” or “between about x and about y” or “between approximate x and y” or “between approximately x-y) is to be understood as referring to the ranges including end points and all subranges between x and y, e.g., between about X and Y includes all ranges x and y, where x is greater than X and y is less than Y.

The term “gpt” or “gptg” means gallons per thousand gallons. The term “pptg” or “ppt” means pounds per thousand gallons.

The term “wt. %” means weight percent.

The term “w/w” means weight per weight.

The term “vol. %” means volume percent.

The term “v/v” means volume per volume.

The term “w/v” means weight per volume.

The term “v/w” means volume per weight.

The term “downhole fluid” or “downhole fluid composition” means any fluid using during any downhole operations such as drilling, fracturing, stimulating, completing, zone isolating, or any other downhole operations. Downhole fluids or downhole fluid compositions include, without limitation, drilling fluids (e.g., low viscosity or high viscosity drilling fluids), fracturing fluids (e.g., slickwater, low viscosity, or high viscosity fracturing fluids with or without proppants), stimulating fluids (e.g., slickwater, low viscosity, or high viscosity fracturing fluids with or without proppants), zone isolation fluids, or any other low or high viscosity fluid used in downhole operations.

The term “fracturing” refers to the process and methods of breaking down a geological formation, i.e., the rock formation around a well bore, by pumping fluid at very high pressures, in order to increase production rates from a hydrocarbon reservoir. The fracturing methods of this disclosure use otherwise conventional techniques known in the art.

The term “under fracturing conditions” means injecting or pumping a fracturing fluid into a formation at a sufficient pressure, at a sufficient temperature (normally not an issue), and for a time sufficient to form fractures or fissures in the formation.

The term “proppant” refers to a granular substance suspended in the fracturing fluid during the fracturing operation, which serves to keep the formation from closing back down upon itself once the pressure is released. Proppants envisioned by the present disclosure include, but are not limited to, conventional proppants familiar to those skilled in the art such as sand, 20-40 mesh sand, resin-coated sand, sintered bauxite, glass beads, and similar materials.

The term “acrylamide containing polymers” and “polyacrylamide containing polymers” are used interchangeably and means that the polymers include acrylamide as a major monomer making up the polymer backbone. Generally, the term major in this setting means the polymers include at least 30% acrylamide, at least 40% acrylamide, at least 40% acrylamide, at least 50% acrylamide, at least 60% acrylamide, at least 70% acrylamide, at least 80% acrylamide, at least 90% acrylamide, or 100% acrylamide. It should be recognized that these ranges include all subranges such as 30% to 100% or any other range or any other at least percentage.

The term “downhole base fluid” means a water-based fluid or an oil-based fluid.

The term “drilling” refers to drilling from a surface location into any subterranean oil and/or gas bearing formation.

The term “drilling fluid(s)” or “drilling fluid composition(s)” refer to fluids or fluid compositions used in drilling an oil and/or gas well from a surface location into to any subterranean oil and/or gas bearing formation.

The terms “treat,” “treatment,” “treating,” and grammatical equivalents thereof refer to any subterranean oil and/or gas bearing formation operation that uses a fluid or fluid composition to achieve a desired function and/or for a desired purpose. Use of these terms does not imply any particular action by the treating fluid or fluid composition.

The term “treating fluid(s)” or “treating fluid composition(s)” refers to downhole fluids used in treating subterranean oil and/or gas bearing formations including, without limitation: (a) fracturing fluid compositions including slickwater fracturing fluid compositions, high viscosity treating fluid compositions, non-proppant-containing fracturing fluid compositions, and proppant-containing fracturing fluids, (b) completion fluid compositions, (c) stimulation fluid compositions, (d) zone isolation fluid compositions, or (e) any other downhole fluid composition.

The term “cracks”, “microcracks”, “fissures”, “microfissures”, “fractures”, or “microfactures” refers to create or enhance openings in the formation, where the term micro refers to smaller openings in the formation. Under fracturing conditions, the enhanced or created openings of fractures will generally have an elongated profile.

The term “friction reducing (FR) polymers” refers to polymers used to reduce friction of a fracturing fluid as it is pumped through fracturing mechanisms into the formation to be fractured or to reduce frictional losses due to friction between an aqueous fluid in turbulent flow and tubular goods (e.g., pipes, coiled tubing, etc.) and/or the formation.

The term “FR base fluid” refers to the major component of the water-based (WB)-FR slurry compositions of this disclosure (as opposed to components dissolved and/or suspended therein), and does not indicate any particular condition or property of that fluid such as its mass, amount, pH, etc.

The term “polymer” or “polymeric material” means or includes natural and synthetic homopolymers, copolymers, terpolymers, etc.

The term “copolymer,” as used herein, means natural and synthetic polymers including two or more monomers or monomeric units, e.g., terpolymers, tetrapolymers, etc.

The term “base fluid” refers to aqueous base fluids and non-aqueous or oil-based base fluids.

The term “aqueous base fluid” refers to base fluids for preparing water-based downhole fluid compositions of this disclosure using one or more water sources including, without limitation, fresh water, saltwater (e.g., water containing one or more salts dissolved therein), brine (e.g., saturated saltwater), seawater, produced water, high total dissolved solids (TDS) waters, surface water (e.g., from a river or a pond), reclaimed water, any other water useable in downhole operations, or any combination thereof.

The term “non-aqueous base fluids” or “oil-based base fluids” refers to base fluids for preparing oil-based downhole fluid compositions of this disclosure using one or more oil-base fluid including, without limitation, one or more refined petroleum products, one or more synthetic non-aqueous products derived from refined petroleum products, or mixtures thereof.

While embodiments of this disclosure have been described and/or depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only and are not exhaustive of the scope of the disclosure.

### DETAILED DESCRIPTION

The inventors have found that highly concentrated particulate friction-reducing polymer slurry (HCPFRPS) compositions and downhole fluid compositions made therefrom may be formulated, wherein the HCPFRPS compositions include one or more solvents, one or more suspending agents, one or more suspending aids, one or more viscosity modifying agents, one or more surfactants, and one or more particulate friction-reducing polymers. The inventors have also found that the HCPFRPS compositions may be formulated according to addition/mixing protocols. The inventors may be used in all downhole operations including drilling, completing, and treating oil/gas producing formations. The inventors have also found that the HCPFRPS compositions may be hydrated within the downhole base fluid to form the downhole fluid compositions. The inventors have also found that by optimizing properties of the HCPFRPS compositions, the formulated downhole fluid compositions may have improved percent friction reduction, which may also be referred to as percent drag reduction (% DR), values. The improved percent friction reduction may be achieved by modifying properties including: (a) an amount of each of the one or more FR polymers utilized in the HCPFRPS compositions, (b) an amount of the HCPFRPS composition, (c) an amount of the base fluid composition utilized to form the downhole fluid compositions, (d) a type of the base fluid composition utilized to form the downhole fluid compositions, and/or (e) amount of each of the downhole fluid compositions utilized to form the downhole fluid compositions. In certain embodiments, the base fluid composition is an aqueous base fluid composition comprising fresh water, brackish water, salt water, sea water, produced water, flowback water, or combinations thereof.

Embodiments of the present disclosure provide highly concentrated particulate friction-reducing polymer slurry (HCPFRPS) compositions including one or more solvents, one or more suspending agents, one or more suspending aids, one or more viscosity modifying agents, one or more surfactants, and one or more particulate friction-reducing polymers. The one or more solvents include one or more mineral oils, other similar petroleum alkane products, or mixtures thereof. The one or more suspending agents include one or more hydrophobic/organophilic particulate solid suspending agents, one or more polymeric suspending agents, or mixtures thereof. The one or more suspending aids include one or more amide compounds, one or more urea-containing compounds, one or more carbamate-containing compounds, or mixtures thereof. The one or more viscosity modifying agents include one or more amphiphilic viscosity modifying agents, one or more polymeric viscosity modifying agents, or mixtures thereof. The one or more surfactants include one or more cationic surfactants, one or more anionic surfactants, one or more zwitterionic surfactants, one or more non-ionic surfactants, or mixtures thereof. The one or more particulate friction-reducing polymers include one or more acrylamide homopolymers (neutral, anionic, cationic, and/or zwitterionic), one or more acrylamide containing polymers, or mixtures thereof.

The inventors have also found that the one or more friction-reducing polymers (e.g., dry particulate acrylamide homo polymers, acrylamide-containing polymers, or mixtures thereof) may be coated with an oil-based carrier, wherein the oil-based carrier includes one or more solvents, one or more suspending agents, one or more suspending aids, one or more viscosity modifying agents, and one or more surfactants, wherein the hydrocarbon solvents and the surfactants reduce or eliminate inter-particle adhesion, aggregation, and clumping of the one or more friction-reducing polymers and the one or more suspending agents, the one or more suspending aids, and the one or more viscosity modifiers. The polymer granules coated by one or more hydrocarbon solvents and one or more surfactants may form a barrier preventing particle-to-particle cohesion. The oil-based carrier in the slurry also may insulate the one or more friction-reducing polymers from moisture exposure in the environment to prevent premature hydration, which may degrade and destabilize the fluid. Providing the one or more friction-reducing polymers in a pre-suspended rather than dry form also may promote rapid dispersion of the one or more friction-reducing polymers into the oil-based carrier fluid on site. When the slurry is added to water, then the slurried one or more friction-reducing polymers may disperse with minimal particle clumping (sometimes referred to as “fish eyes”).

Promoting dispersal may improve particle hydration, which, in turn, may enhance overall performance by reducing the drag caused by particle aggregation. In flow loop tests, the slurry of the present disclosure out-performs dry particulate one or more friction-reducing polymers in terms of enhanced percent drag reduction (% DR) by preventing fish eye formation.

In contrast to known compositions, the present HCPFRPS compositions include an oil-based carrier including one or more solvents, one or more suspending agents, one or more suspending aids, one or more viscosity modifying agents, and one or more surfactants. In certain embodiments, the one or more surfactants include one or more nonionic surfactants. In other embodiments, the one or more suspending agents include one or more soluble polymeric suspending agents, one or more hydrophobic/organophilic particulate solid suspending agents, or mixtures thereof. It should be recognized that the present compositions do not require traditional emulsion polymerization polymers at all. Eliminating the need for traditional polymerization reactions, in turn, eliminates the demands of temperature control and the need for equipment such as chemical reactors. As such, the present compositions may have improved environmental impact. Additionally, the oil-based carriers of this disclosure may make the present compositions easier to manufacture and less resource intensive.

### COMPOSITIONAL RANGES OF THE COMPOSITIONS OF THIS DISCLOSURE

HCPFRPS Compositional Ranges

Table 1 sets forth the ingredients, properties, and the ranges of the HCPFRPS compositions of this disclosure.

TABLE 1
Ingredient, Property and Ranges

| | Ranges | Ranges | Ranges |
|---|---|---|---|
| Ingredient | (wt. %) | (wt. %) | (wt. %) |
| one or more particulate | about 50 to | about 50 to | about 60 to |
| friction-reducing | about 80 | about 75 | about 75 |
| (FR) polymers | | | |
| oil-based carrier | about 50 to | about 50 to | about 40 to |
| composition | about 20 | about 25 | about 25 |

In certain embodiments, the HCPFRPS compositions include between about 50 wt. % and about 80 wt. % of the one or more particulate FR polymers and between about 50 wt. % and about 20 wt. % of the oil-based carrier composition and all subranges therein. In other embodiments, the HCPFRPS compositions include between about 55 wt. % and about 80 wt. % of the one or more particulate FR polymers and between about 45 wt. % and about 20 wt. % of the oil-based carrier composition and all subranges therein. In other embodiments, the HCPFRPS compositions include between about 60 wt. % and about 80 wt. % of the one or more particulate FR polymers and between about 40 wt. % and about 20 wt. % of the oil-based carrier composition and all subranges therein. In other embodiments, the HCPFRPS compositions include between about 65 wt. % and about 80 wt. % of the one or more particulate FR polymers and between about 35 wt. % and about 20 wt. %

of the oil-based carrier composition and all subranges therein. In other embodiments, the HCPFRPS compositions include between about 70 wt. % and about 80 wt. % of the one or more particulate FR polymers and between about 30 wt. % and about 20 wt. % of oil-based carrier composition and all subranges therein. In other embodiments, the HCPFRPS compositions include between about 75 wt. % and about 80 wt. % of the one or more particulate FR polymers and between about 25 wt. % and about 20 wt. % of the oil-based carrier composition and all subranges therein.

### HCPFRPS Oil-Based Carrier Compositional Ranges

Table 2 sets forth the ingredients, properties, and the ranges of the oil-based carrier compositions of this disclosure.

TABLE 2
Ingredient, Property and Ranges

| | Ranges | Ranges | Ranges | Ranges |
|---|---|---|---|---|
| Ingredient | (wt. %) | (wt. %) | (wt. %) | (wt. %) |
| one or more oil-based | about 100 to | about 99 to | about 95 to | about 92.5 |
| solvents | about 80 | about 85 | about 85 | to about 85 |
| one or more polymeric | about 0 to | about 0.1 | about 0.1 to | 0.1 to |
| suspending agents | about 5 | to about 5 | about 5 | about 4 |
| one or more clay | about 0 to | about 0.1 | about 0.1 to | 0.1 to |
| suspending agents | about 5 | to about 5 | about 5 | about 4 |
| one or more suspending | about 0 to | about 0.1 | about 0.1 to | 0.1 to |
| aids | about 5 | to about 5 | about 5 | about 4 |
| one or more viscosity | about 0 to | about 0.1 | about 0.1 to | 0.1 to |
| modifying agents | about 5 | to about 5 | about 2.5 | about 2 |
| one or more dispersing | about 0 to | about 0.1 | about 0.1 to | 0.1 to |
| agents | about 5 | to about 5 | about 2 | about 1 |

In certain embodiments, the oil-based carrier compositions include between about 100 wt. % to about 80 wt. % of the one or more oil-based solvents, between about 0 wt. % to about 5 wt. % of the one or more suspending agents, between about 0 wt. % to about 5 wt. % of the one or more suspending aids, between about 0 wt. % to about 5 wt. % of the one or more viscosity modifying agents, and between about 0 wt. % to about 5 wt. % of the one or more dispersing agents and all subranges therein. In certain embodiments, the oil-based carrier compositions include between about 100 wt. % to about 84 wt. % of the one or more oil-based solvents, between about 0.01 wt. % to about 4 wt. % of the one or more suspending agents, between about 0.01 wt. % to about 4 wt. % of the one or more suspending aids, between about 0.01 wt. % to about 4 wt. % of the one or more viscosity modifying agents, and between about 0.01 wt. % to about 4 wt. % of the one or more dispersing agents and all subranges therein. In certain embodiments, the oil-based carrier compositions include between about 100 wt. % to about 88 wt. % of the one or more oil-based solvents, between about 0.01 wt. % to about 3 wt. % of the one or more suspending agents, between about 0.01 wt. % to about 3 wt. % of the one or more suspending aids, between about 0.01 wt. % to about 3 wt. % of the one or more viscosity modifying agents, and between about 0.01 wt. % to about 3 wt. % of the one or more dispersing agents and all subranges therein. In certain embodiments, the oil-based carrier compositions include between about 100 wt. % to about 92 wt. % of the one or more oil-based solvents, between about 0.01 wt. % to about 2 wt. % of the one or more suspending agents, between about 0.01 wt. % to about 2 wt. % of the one or more suspending aids, between about 0.01 wt. % to about 2 wt. % of the one or more viscosity modifying agents, and between about 0.01 wt. % to about 2 wt. % of the one or more dispersing agents and all subranges therein. In certain embodiments, the oil-based carrier compositions include between about 100 wt. % to about 96 wt. % of the one or more oil-based solvents, between about 0.01 wt. % to about 1 wt. % of the one or more suspending agents, between about 0.01 wt. % to about 1 wt. % of the one or more suspending aids, between about 0.01 wt. % to about 1 wt. % of the one or more viscosity modifying agents, and between about 0.01 wt. % to about 1 wt. % of the one or more dispersing agents and all subranges therein. In certain embodiments, the one or more oil-based solvents comprise one or more hydrocarbon solvents, one or more petroleum distillates, one or more synthetic non-aqueous solvents, one or more mineral oils, or any combination thereof; the one or more suspending agents comprise one or more soluble polymeric suspending agents, one or more hydrophobic/organophilic particulate solid suspending agents, or mixtures thereof; the one or more suspending aids comprising one or more amide compounds, one or more urea-containing compounds, one or more carbamate-containing compounds, or mixtures thereof; and the one or more dispersing agents comprise one or more nonionic surfactants.

The slurry compositions of the present disclosure have about 30% to about 50% greater hydration capacity per loading than traditional emulsions depending on water-soluble polymer qualities and water type, which imparts to carrier fluid including the slurry compositions of this disclosure improved proppant carrying capacity. By controlling the slurry viscosity and the hydration viscosity, a user may be able to create a customized proppant carrier fluid that fits particular manufacturing, storage, transport, pump rate, well depth, or other scenarios.

Increasing the polymer loading in the present fluids allows the polymer slurries to utilize lower relative volumes, while achieving the same performance as traditional emulsions. To illustrate, traditional emulsions are typically used at loadings between about 0.50 gpt and about 1.0 gpt in water. Aqueous concentrates require large volumes up to about 8 gpt as well as they comprise mostly water. Slurries of the present disclosure may be used at much lower concentrations, sometimes as low as about 0.05 gpt and about 0.5 gpt, while still providing improved drag reduction performance as compared to traditional emulsions, dry powders, and aqueous liquid concentrate. In other embodiments, the slurry concentration is between about 0.05 gpt and about 0.4 gpt. In other embodiments, the slurry concentration is between about 0.05 gpt and about 0.3 gpt. In other embodiments, the slurry concentration is between about 0.05 gpt and about 0.2 gpt.

In certain embodiments, the approximate size of the particulate FR polymers are between about 20 and about 400 mesh. In other embodiments, the suspension agents comprise polymeric suspending agents such as linear block copolymers, one or more hydrophobic/organophilic particulate solid suspending agents (e.g., organophilic clays), or mixtures thereof.

In other embodiments, the present slurries have between about 30% and about 50% greater hydration capacity per loading than traditional emulsions and imparts to the resulting proppant carrier fluids accordingly better proppant carrying capacity. By controlling the slurry viscosity and the hydration viscosity, a user may create a customized proppant carrier fluid that fits a particular manufacturing, storage, transport, pump rate, well depth, or other scenario.

Additionally, known emulsions are based on high molecular weight polymers, for example polymers having molecular weight of 24 million or higher. Slurries of the present disclosure may utilize lower molecular weight polymers, yet still give comparable drag reduction performance, even at lower loadings. Drag reduction and proppant delivery are the two primary functions of a friction reducer carrier fluid. Using particle size to increase polymer loading also increases the hydration viscosity and the downhole viscosity creating better proppant carrying properties.

The slurries of the present disclosure may also be modified to reduce free fluid in the final manufactured product by adding one or more suspending agents such as one or more synthetic polymeric suspending agents or one or more to oil-based carriers. In other embodiments, the oil-based carriers may include one or more organophilic clays. Traditional emulsions cannot be modified in this way. The addition of the one or more one or more synthetic polymeric suspending agents overcomes potential problems with free fluid and settling, resulting in a more stable product than a traditional emulsion. Alternatively, additional surfactants or adjustments in particle size may be used to reduce free fluid and settling. The reader is referred to United States Published application No. 20170313930A1 for additional information on slurries that may be used to formulate the compositions of this disclosure.

The present disclosure broadly relates to a composition for treatment of subterranean well formations comprising a slurry as set forth above and a water source selected from the group consisting of fresh water, brackish water, salt water, sea water, produced water, flowback water, or combinations thereof; provided the selected water includes a sufficient concentration of ions to reduce gelling interactions of the oppositely charged polymers. In certain embodiments, the composition further comprising a proppant. In certain embodiments, the proppant is sand.

The present disclosure broadly relates to a method of treating a subterranean formation, comprising: hydrating an oil-based slurry and a water source selected from the group consisting of fresh water, brackish water, salt water, sea water, produced water, flowback water, or combinations thereof, provided the selected water includes a sufficient concentration of ions to reduce gelling interactions of the oppositely charged polymers to form a proppant carrier fluid; adding a proppant to the water source; and delivering the carrier fluid and proppant to the subterranean formation.

Embodiments of this disclosure broadly relate to slurry compositions including a mixture of oppositely charged, particulate, water-soluble polymers and an oil-based vehicle or carrier including one or more hydrocarbon solvents, one or more suspending agents, and one or more surfactants.

Polymers for Use in Slurry Compositions

Polymer granules may have different particle sizes. Different particle sizes impart different characteristics to the final product. By choosing a particle size, or a particular ratio of different particle sizes, a user may customize the performance of the slurry or create a product that has varying properties.

In certain embodiments, the friction-reducing polymers individually have (number average or weight average) molecular weights between about 10 million and 40 million and all sub-ranges. In other embodiments, the anionic polymers have a molecular weight between about 15 million and 30 million and all sub-ranges. In other embodiments, the anionic polymers have a molecular weight between about 20 million and 30 million and all sub-ranges. In other embodiments, the anionic polymers have a molecular weight greater than 22 million, e.g., 25 million, 30 million, 35 million, 40 million, 45 million, etc.

### SUITABLE COMPONENTS FOR USE IN THE DISCLOSURE

Suitable hydrocarbon solvents include, without limitation, paraffin containing hydrocarbons, isoparaffin containing hydrocarbons, olefin containing hydrocarbons, cyclic paraffin containing hydrocarbons, cyclic isoparaffin containing hydrocarbons, cyclic olefin containing hydrocarbons, paraffinic naphthenic solvents, and mixtures thereof. In certain embodiments, the hydrocarbon solvents include one or more petroleum distillates. Petroleum distillates are products distilled from petroleum crude oil having different CAS number identifiers depending upon the molecular weight distribution and processing technology used. Exemplary examples of petroleum distillates include, without limitation, a hydrotreated light petroleum distillate having the CAS No. 64742-47-8.

Suitable surfactants include, without limitation, anionic surfactants, cationic surfactants, nonionic surfactants, zwitterionic surfactants, and mixtures or combinations thereof. In certain embodiments, the surfactants include, without limitation, a nonionic surfactant, a mixture of nonionic surfactants, a mixture of nonionic surfactants and zwitterionic surfactants, a mixture of nonionic surfactants and cationic surfactants, a mixture of nonionic surfactants and anionic surfactants, a mixture of nonionic surfactants, cationic surfactants, and zwitterionic surfactants, a mixture of nonionic surfactants, anionic surfactants, and zwitterionic surfactants, or a mixture of nonionic surfactants, cationic surfactants, anionic surfactants, and zwitterionic surfactants.

Exemplary examples of nonionic surfactants include, without limitation, ethoxylated and/or propoxylated (C₈-C₂₀) fatty acids, ethoxylated and/or propoxylated (C₈-C₂₀) fatty alcohols, and/or oxalate propoxy copolymers. A surfactant with an HLB number below that of 9 is considered lipophilic, while an HLB above 11 is considered hydrophilic. HLB values between 9-11 are intermediate. The present polyacrylamide slurry only requires inclusion of a surfactant for desired properties such as stability, inversion, and/or slurry viscosity, which may correspond to anything from 3-16 in HLB value. An emulsion, in contrast, requires specific surfactants for initiation, stability, and dispersion each surfactant having a much narrower HLB range. In certain embodiments, the surfactants may be one or more ethoxylated nonionic surfactants. In other embodiments, the surfactants may be one or more fatty chain EO/PO (ethylene oxide propylene oxide) surfactants and/or one or more oxalate propoxy copolymer surfactants.

Exemplary examples of zwitterionic surfactants include, without limitation, phospholipids, betaines, or mixtures thereof. Phospholipids include any phospholipid or mixtures and combinations thereof such as (1) diacylglyceride phospholipids or glycerophospholipids include, without limitation, phosphatidic acid (phosphatidate) (PA), phosphatidylethanolamine (cephalin) (PE), phosphatidylcholine (lecithin) (PC), phosphatidylserine (PS), phosphoinositides such as phosphatidylinositol (PI), phosphatidylinositol phosphate (PIP), phosphatidylinositol bisphosphate (PIP2) and phosphatidylinositol triphosphate (PIP3), and (2) phosphosphingolipids such as ceramide phosphorylcholine (Sphingomyelin) (SPH), ceramide phosphorylethanolamine (Cer-PE), and ceramide phosphorylglycerol. Amphoteric agents include acetates, betaines, glycinates, imidazolines, propionates, other amphoteric agents or mixtures thereof. Phospholipids from natural sources, such as soy, may comprise saturated phospholipids (e.g., palmitic acid and stearic acid) and unsaturated phospholipids (e.g., oleic acid, linoleic acid and linolenic acid). In certain embodiments, the phospholipids are zwitterionic phospholipids including, without limitation, dipalmitoyl phosphatidylcholine, phosphatidyl choline, or a mixture thereof. Other lecithins include, without limitation, any oil including 10 wt. % to 95 wt. % of one or more phospholipids.

Suitable viscosity modifying agents include, without limitation, amphiphilic viscosity modifying agents, one or more zwitterionic viscosity modifying agents, one or more polymeric viscosity modifying agents, one or more polymeric viscosity modifiers such as olefin copolymer for ethylene, propylene, butylene, etc., one or more styrene olefin copolymers, one or more polymethacrylates, one or more copolymers of methacrylate esters, one or more ethylene propylene oligomers, one or more low viscosity polyalphaolefins, one or more metallocene PAO, or mixtures thereof. Exemplary examples of amphiphilic and/or zwitterionic viscosity modifying agents including, without limitation, quaternary salts, amino acids, other compounds capable of forming or in the form of a zwitterion, or mixtures or combinations thereof.

Suitable suspending agents include, without limitation, any organo soluble polymeric suspending agents, one or more hydrophobic/organophilic particulate solid suspending agents, or mixtures thereof. Exemplary examples of organo soluble polymeric suspending agent are agents capable of suspending or dispersing the polymer particles and reducing particle settling. In certain embodiments, the organo soluble polymeric suspension agents include, without limitation, styrene containing polymers, styrene containing copolymers, styrene containing block copolymers, styrene/ethylene block copolymers, styrene/propylene block copolymers, styrene/ethylene/propylene block copolymers, styrene/acrylic acid block copolymers, styrene/methacrylic acid block copolymers, styrene/acrylate block copolymers, styrene/methacrylate block copolymers, styrene/isoprene copolymers, styrene/butadiene copolymers, styrene/butadiene/isoprene copolymers, styrene/acrylic acid/ethylene block copolymers, styrene/methacrylic acid/ethylene block copolymers, styrene/acrylate/ethylene block copolymers, styrene/methacrylate/ethylene block copolymers, styrene/isoprene/ethylene copolymers, styrene/butadiene/ethylene copolymers, styrene/butadiene/isoprene/ethylene copolymers, styrene/acrylic acid/propylene block copolymers, styrene/methacrylic acid/propylene block copolymers, styrene/acrylate/propylene block copolymers, styrene/methacrylate/propylene block copolymers, styrene/isoprene/propylene copolymers, styrene/butadiene/propylene copolymers, styrene/butadiene/isoprene/propylene copolymers, styrene/acrylic acid/ethylene/propylene block copolymers, styrene/methacrylic acid/ethylene/propylene block copolymers, styrene/acrylate/ethylene/propylene block copolymers, styrene/methacrylate/ethylene/propylene block copolymers, styrene/isoprene/ethylene/propylene copolymers, styrene/butadiene/ethylene/propylene copolymers, styrene/butadiene/isoprene/ethylene/propylene copolymers, and mixtures thereof. In certain embodiments, the block copolymers are linear block copolymers. Exemplary examples of suspending agents include, without limitation, linear diblock copolymers based on styrene and ethylene/propylene, or mixtures thereof. A styrene/ethylene/propylene-(styrene) polymer is a thermoplastic elastomer that is easy to manufacture and effective in helping keep the particular water-soluble polymer in suspension.

Exemplary KRATON® block polymers (KRATON is a registered trademark of KRATON POLYMERS US LLC) include: (1) KRATON® A products (linear triblock copolymer based on styrene and ethylene/butylene) including, without limitation, KRATON® A1535, KRATON® A1536, KRATON® A1537, or mixtures thereof; (2) KRATON® D (SBS blocks) products including KRATON® D0243E, KRATON® D1118K, KRATON® D1192A, KRATON® D0243K, KRATON® D1152E, KRATON® D1192E, KRATON® D1101A, KRATON® D1155E, KRATON® D1192K, KRATON® D1101E, KRATON® D1155J, KRATON® D4150K, KRATON® D1101J, KRATON® D1157E, KRATON® D4153E, KRATON® D1101K, KRATON® D1184A, KRATON® DX405J, KRATON® D1102E, KRATON® D1184E, KRATON® DX408J, KRATON® D1102J, KRATON® D1184K, KRATON® DX410J, KRATON® D1116A, KRATON® D1191E, KRATON® DX423J, KRATON® D1118E, KRATON® MDB703, KRATON® MD8703, or mixtures thereof; (3) KRATON® D (SBS blocks milled) including, without limitation, KRATON® D1101A, KRATON® D1118E, KRATON® D1184K, KRATON® D1101J, KRATON® D1118K, KRATON® D1191E, KRATON® D1101K, KRATON® D1152E, KRATON® D1192A, KRATON® D1116A, KRATON®D1157E, KRATON® D1192E, KRATON® D1184A, KRATON® D4153E, or mixtures thereof; (4) KRATON® D (SIS blocks) including, without limitation, KRATON® D1111K, KRATON® D1126P, KRATON® D1163J, KRATON® D1113P, KRATON®D1161K, KRATON® D1163P, KRATON® D1114P, KRATON® D1161J, KRATON® D1164P, KRATON® D1117P, KRATON® D1161P, KRATON® D1165P, KRATON® D1119P, KRATON® D1162P, KRATON® D1183P, KRATON® D1124P, KRATON® D1193P, or mixtures thereof; (5) KRATON® D (SIS blocks milled) including, without limitation, KRATON® D1161P; (6) KRATON® D (SIBS) including, without limitation, KRATON® D1171P; (7) KRATON® FG (S-Ethylene/butylene-triblocks) including, without limitation, KRATON® FG1901 G Polymer, KRATON® FG1924 G Polymer, or mixtures thereof; (8) KRATON® G (SEBS) including, without limitation, KRATON® E1830M, KRATON® G1652E, KRATON® G1657M, KRATON® E1830H, KRATON®G1652M, KRATON® G1660H, KRATON® G1633E, KRATON® G1653V, KRATON® G1726V, G1650E, KRATON® G1654E, KRATON® G1726M, G1650M, KRATON® G1654H, KRATON® G4609H, KRATON® G1651E, KRATON® G1657V KRATON® G4610H, KRATON® G1651H, or mixtures thereof; (9) KRATON® G SEP(S) including, without limitation, KRATON® G1701M, KRATON® G1702H, KRATON® G1730V, or mixtures thereof; (10) KRATON® G (ERS) including, without limitation, KRATON® G1640E, KRATON® G1643V, KRATON® G1641H, KRATON® G1645V, KRATON® G1642H, KRATON® G1646V, or mixtures thereof; and (11) KRATON® G (EP) including, without limitation, KRATON® G1750V, KRATON® G1765, or mixtures thereof; and (12) mixtures thereof.

In certain embodiments, the suspending agents may also further include one or more organophilic clays such as Claytone SF. In other embodiments, the organophilic clays include, without limitation, bentonite clays, hectorite clays, attapulgite clays, ant/or sepiolite clays, which may be treated with organic materials to render the clays organophilic.

Exemplary examples of hydrophobic/organophilic particulate solid suspending agents include, without limitation, BARAGEL® clays (BARAGEL is a registered trademark of Halliburton Energy Services, Inc.) including BARAGEL® 10, BARAGEL® 20, BARAGEL® 34 GGm, or BARAGEL® 3000; BENATHIX® clays (BENATHIX is a registered trademark of Elementis Specialties, Inc.); BENGEL® clays (BENGEL is a registered trademark of Elementis Specialties, Inc.) including BENGEL® 62, BENGEL® 434, BENGEL® 818, or BENGEL® 958; BENTONER clays including (BENTONE is a registered trademark of Elementis Specialties, Inc.) BENTONE® 27, BENTONE® 30, BENTONER 34, BENTONER 38, BENTONER 42, BENTONER 52, BENTONER 54, BENTONER 57, BENTONER 150, BENTONER 155, BENTONER 910, BENTONER 920, BENTONER 990, BENTONE® 1000, BENTONER SD-1, BENTONER SD-2, BENTONER SD-3, BENTONER NP-10, or BENTONER GEL 2; BYK® clays including (BYK is a registered trademark of BYK-CHEMIE GMBH) BYK®-MAX CT 4275; CLAYTONER clays including (CLAYTONE is a registered trademark of BYK-CHEMIE GMBH) CLAYTONER-40, CLAYTONER-7840, CLAYTONER-AF, CLAYTONER-APA, CLAYTONER-APA V, CLAYTONER-APA V XR, CLAYTONER-HY, CLAYTONER-MPZ V, CLAYTONER-MPZ V XR, CLAYTONER-MPZ, CLAYTONER-PI, CLAYTONER SF, CLAYTONER-VP V, CLAYTONER-VP V XR, CLAYTONER-VZ, CLAYTONER-VZ V, or CLAYTONE®-VZ V XR; GARAMITE® clays (GARAMITE is a registered trademark of BYK-CHEMIE GMBH) including GARAMITE®-1210, GARAMITE®-1958, GARAMITE®-7303, GARAMITE®-7305, GARAMITE®-7308, or GARAMITER-7308 XR; RHEOBYK™ clays (RHEOBYK including is a trademark of BYK-CHEMIE GMBH) RHEOBYK®-7405, or RHEOBYK®-R 606; TIXOGEL® clays (TIXOGEL is a registered trademark of BYK-CHEMIE GMBH) including TIXOGEL®-CCT, TIXOGEL®-DMC, TIXOGEL®-FTN, TIXOGEL®-IDD, TIXOGEL®-IIN, or TIXOGEL®-VSP, or mixtures or combinations thereof.

Suitable suspending aids include, without limitation, any organic thixotropic agent. Exemplary examples of thixotropic agents include, without limitation, castor oils, hydrogenated castor oils, castor waxes, one or more amide compounds, one or more urea-containing compounds, one or more carbamate-containing compounds, or mixtures thereof. Suitable amide compounds include, without limitation, one or more monoamide compounds, one or more diamide compounds, one or more polyamide compounds, or mixtures thereof. Exemplary examples of the one or more monoamide compounds comprise compounds of formula:

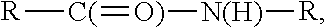

wherein the R groups are the same of different linear, branched, or substituted hydrocarbyl groups. Exemplary examples of the one or more diamide compounds comprise compounds of formula:

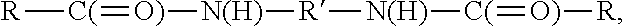

wherein the R groups are the same of different linear, branched, or substituted hydrocarbyl groups and the R′ group is a linear alkenyl linking group. Exemplary examples of the one or more polyamide compounds comprise one or more linear polyamide compounds of formula:

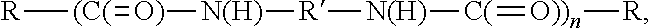

wherein the R groups are the same of different linear, branched, or substituted hydrocarbyl groups, the R′ groups are the same or different linear alkenyl linking groups, and n is an integer having a value between 2 and 10. Exemplary examples of the one or more polyamide compounds comprise one or more branched polyamide compounds of formula:

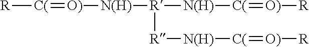

wherein the R groups are the same of different linear, branched, or substituted hydrocarbyl groups and the R′ and R″ groups are the same or different linear alkenyl linking groups. Exemplary examples of the one or more monourea compounds comprise compounds of formula:

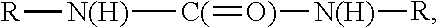

wherein the R groups are the same of different linear, branched, or substituted hydrocarbyl groups. Exemplary examples of the one or more diurea compounds comprise compounds of formula:

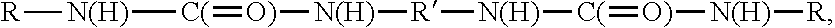

wherein the R groups are the same of different linear, branched, or substituted hydrocarbyl groups and the R′ group is a linear alkenyl linking group. Exemplary examples of the one or more polyurea compounds comprise one or more linear polyurea compounds of formula:

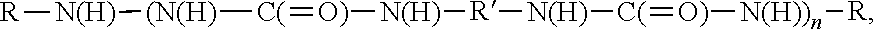

wherein the R groups are the same of different linear, branched, or substituted hydrocarbyl groups, the R′ groups are the same or different linear alkenyl linking groups, and n is an integer having a value between 2 and 10. Exemplary examples of the one or more polyurea compounds comprise one or more branched polyurea compounds of formula:

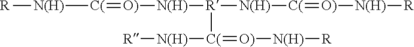

wherein the R groups are the same of different linear, branched, or substituted hydrocarbyl groups and the R′ and R″ groups are the same or different linear alkenyl linking groups. Exemplary examples of the one or more monocarbamate compounds comprise compounds of formula:

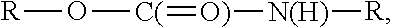

wherein the R groups are the same of different linear, branched, or substituted hydrocarbyl groups. Exemplary examples of the one or more dicarbamate compounds comprise compounds of formula:

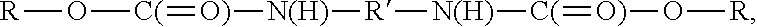

wherein the R groups are the same of different linear, branched, or substituted hydrocarbyl groups and the R′ group is a linear alkenyl linking group. Exemplary examples of the one or more polyamide compounds comprise one or more linear polycarbamate compounds of formula:

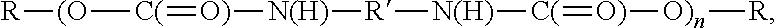

wherein the R groups are the same of different linear, branched, or substituted hydrocarbyl groups, the R′ groups are the same or different linear alkenyl linking groups, and n is an integer having a value between 2 and 10. Exemplary examples of the one or more polycarbamate compounds comprise one or more branched polycarbamate compounds of formula:

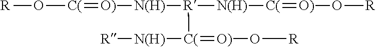

wherein the R groups are the same of different linear, branched, or substituted hydrocarbyl groups and the R′ and R″ groups are the same or different linear alkenyl linking groups. Other exemplary examples include, without limitation, THIXATROL® ST, THIXATROL® MAX, THIXATROL® 8053, THIXATROL® 8054, THIXATROL® 8056, THIXATROL® 8058, or other amide containing thixotropes, available from Elementis or BYK-GO 8730, BYK-GO 8721, BYK-GO 8780, BYK-GO 8750, BYK-GO 8720, BYK-GO 8711, BYK-GO 8700, BYK-GO 8702, BYK-GO 8701, GARAMITE®-1958, a powdered rheology & thixotropic additive based on a composition of organically modified phyllosilicates, GARAMITER-7305, a thixotropic additive based on organically modified phyllosilicates, RHEOBYK®-410, a liquid rheology additive, RHEOBYKR-7410 ET, a liquid rheology additive, RHEOBYK®-D 410, a liquid rheology additive, RHEOBYK®-R 605 a liquid, rheology additive, RHEOBYK® R-605 SG a thixotropic-reinforcing additive, more available from BYK, or mixtures and combinations thereof.

Suitable particulate friction-reducing polymers include, without limitation, one or more acrylamide homopolymers (neutral, anionic, cationic, or zwitterionic), one or more acrylamide-containing polymers, or mixtures thereof. Exemplary examples of anionic acrylamide polymers include sodium, potassium, rubidium, and/or cesium anionic polyacrylamide (APAM) polymers of formula-(˜[CH2CH (CONH2)] m-[CH2CH (COOM)] n—)—(wherein M is sodium, potassium, rubidium, and/or cesium), neutral polyacrylamide (PAM) polymers of formula-(CH2CH (CONH2)) m—, cationic polyacrylamide (CPAM) polymers of formula-(˜[CH2CH (CONH2)] m-[CH2CH (COORN+ (R′) 3Cl—)] n—)—, zwitterionic acrylamide copolymers of acrylamide and 3-dimethyl (methacryloyloxyethyl) ammonium propane sulfonate (DMAPS), mixtures of anionic acrylamide polymers and cationic acrylamide polymers, mixtures of anionic acrylamide polymers and zwitterionic acrylamide copolymers, mixtures of cationic acrylamide polymers and zwitterionic acrylamide copolymers, mixtures of anionic acrylamide polymers, neutral acrylamide polymers, and cationic acrylamide polymers, mixtures of anionic acrylamide polymers, zwitterionic acrylamide copolymers, and cationic acrylamide polymers, and mixtures of anionic acrylamide polymers, zwitterionic acrylamide copolymers, neutral acrylamide polymers, and cationic acrylamide polymers. In other embodiments, the acrylamide polymers include synthetic polymers and copolymers such as vinyl alcohol containing polymers and copolymers, acrylamide containing polymers and copolymers, 2-amino-2-methyl propane sulfonic acid (AMPS) containing polymers and copolymers, other synthetic polymers and copolymers, and mixtures or combinations thereof. In other embodiments, the copolymers may include other ethylenically unsaturated monomers including, without limitation, ethylene, propylene, acrylic acid, methacrylic acid, other similar monomers and mixtures or combinations thereof. Exemplary examples include, without limitation, polymers of acrylamide or acrylamide and AMPS such as SNF 7115 FG, A-FRD 33, SDF-8405, SDF-8410, SDF-8415, SDF-8420, SDF-8425, S-FRD D, S-FRD C, S-FRD 42, S-FRD A, S-FRD B, S-FRD 12, S-FRD 32, S-FRD 46, A-FRD 12, or mixtures thereof.

Polyacrylamide is a hydrophilic, water-soluble polymer that can comprise nonionic, cationic, anionic, or zwitterionic charge. Hydrated polyacrylamide of powder origins can reduce friction and turbulence in a system allowing faster pump rates and reducing pumping pressures all while carrying sufficient proppant for typical oil and gas well applications. Dry powder polyacrylamide can be hard to utilize as it absorbs ambient moisture and is prone to aggregation and clump formation. Decreasing the particle size of the powder enhances the hydration and inversion rate of the polyacrylamide, but exacerbates the powder's absorption of moisture.

The polymer particles may have sizes or particle size distributions between about 250 microns and about 0.001 microns, between about 200 microns and about 0.001 microns, between about 150 microns and about 0.001 microns, between about 100 microns and about 0.001 microns, between about 50 microns and about 0.001 microns, between about 25 microns and about 0.001 microns, between about 10 microns and about 0.001 microns, between about 5 microns and about 0.001 microns, and all subranges.

Suitable proppants for use in this disclosure include, without limitation, particulate metal oxides, particulate ceramics, particulate natural solids such as sand, particulate synthetic solids, particulate metals, particulate plastics, particulate polymers, particulate plant materials, any other solid material that may find use in downhole fluids or mixtures and combinations thereof. Metal oxides include, without limitation, any solid oxide of a metallic element of the periodic table of elements. Exemplary examples of metal oxides and ceramics include actinium oxides, aluminum oxides, antimony oxides, boron oxides, barium oxides, bismuth oxides, calcium oxides, cerium oxides, cobalt oxides, chromium oxides, cesium oxides, copper oxides, dysprosium oxides, erbium oxides, europium oxides, gallium oxides, germanium oxides, iridium oxides, iron oxides, lanthanum oxides, lithium oxides, magnesium oxides, manganese oxides, molybdenum oxides, niobium oxides, neodymium oxides, nickel oxides, osmium oxides, palladium oxides, potassium oxides, promethium oxides, praseodymium oxides, platinum oxides, rubidium oxides, rhenium oxides, rhodium oxides, ruthenium oxides, scandium oxides, selenium oxides, silicon oxides, samarium oxides, silver oxides, sodium oxides, strontium oxides, tantalum oxides, terbium oxides, tellurium oxides, thorium oxides, tin oxides, titanium oxides, thallium oxides, thulium oxides, vanadium oxides, tungsten oxides, yttrium oxides, ytterbium oxides, zinc oxides, zirconium oxides, ceramic structures prepared from one or more of these oxides and mixed metal oxides including two or more of the above listed metal oxides. Exemplary examples of plant materials include, without limitation, shells of seed bearing plants such as walnut shells, pecan shells, peanut shells, shells for other hard shelled seed forming plants, ground wood or other fibrous cellulosic materials, or mixtures or combinations thereof.

### EXPERIMENTS OF THE DISCLOSURE

### Example 1

This example illustrates a highly concentrated particulate friction-reducing polymer slurry (HCPFRPS) composition.

The HCPFRPS includes the following ingredients:

| Component | Percentage |
|---|---|
| Mineral Oil | 29% |
| Suspending Aid | 0.2% |
| Clay-Based Suspending Agent | 0.7% |
| Viscosity Modifier | 0.3% |
| Dispersing Nonionic Surfactant | 0.3% |
| FR Acrylamide-Containing Polymer | 69.5% |
| | 100.0% |

### Example 2

This example illustrates a highly concentrated particulate friction-reducing polymer slurry (HCPFRPS) composition.

The HCPFRPS includes the following ingredients:

| Component | Percentage |
|---|---|
| Mineral Oil | 29.0% |
| Suspending Aid | 0.2% |
| Polymer-Based Suspending Agent | 0.7% |
| Viscosity Modifier | 0.3% |
| Dispersing Nonionic Surfactant | 0.3% |
| FR Acrylamide-Containing Polymer | 69.5% |
| | 100.0% |

### Examples 3-54

These examples illustrate highly concentrated particulate friction-reducing polymer slurry (HCPFRPS) compositions.

The HCPFRPS compositions include the following ingredients:

| | | | Clay | Polymer | Viscosity | | Friction | |
|---|---|---|---|---|---|---|---|---|
| | | Suspending | Suspending | Suspending | Modifying | Dispersing | Reducing | |
| | Oil | Aids | Agent | Agent | Agent | Agent | Polymer | Total |
| # | (wt. %) | (wt. %) | (wt. %) | (wt. %) | (wt. %) | (wt. %) | (wt. %) | (wt. %) |
| 3 | 25.0 | 1.00 | 0.00 | 0.00 | 0.50 | 0.50 | 73.0 | 100.0 |
| 4 | 25.0 | 0.0 | 1.0 | 0.0 | 0.50 | 0.50 | 73.0 | 100.0 |
| 5 | 25.0 | 0.0 | 0.0 | 1.0 | 0.50 | 0.50 | 73.0 | 100.0 |
| 6 | 25.0 | 0.5 | 0.5 | 0.0 | 0.50 | 0.50 | 73.0 | 100.0 |
| 7 | 25.0 | 0.0 | 0.5 | 0.5 | 0.50 | 0.50 | 73.0 | 100.0 |
| 8 | 25.0 | 0.5 | 0.0 | 0.5 | 0.50 | 0.50 | 73.0 | 100.0 |
| 9 | 30.0 | 0.3 | 0.8 | 0.0 | 0.50 | 0.50 | 68.0 | 100.0 |
| 10 | 30.0 | 0.3 | 0.0 | 0.8 | 0.50 | 0.50 | 68.0 | 100.0 |
| 11 | 30.0 | 0.0 | 0.3 | 0.8 | 0.50 | 0.50 | 68.0 | 100.0 |
| 12 | 30.0 | 0.0 | 0.8 | 0.3 | 0.50 | 0.50 | 68.0 | 100.0 |
| 13 | 45.0 | 4.0 | 0.0 | 0.0 | 0.50 | 0.50 | 50.0 | 100.0 |
| 14 | 45.0 | 0.0 | 4.0 | 0.0 | 0.50 | 0.50 | 50.0 | 100.0 |
| 15 | 45.0 | 0.0 | 0.0 | 4.0 | 0.50 | 0.50 | 50.0 | 100.0 |
| 16 | 45.0 | 2.0 | 2.0 | 0.0 | 0.50 | 0.50 | 50.0 | 100.0 |
| 17 | 45.0 | 0.0 | 2.0 | 2.0 | 0.50 | 0.50 | 50.0 | 100.0 |
| 18 | 45.0 | 2.0 | 0.0 | 2.0 | 0.50 | 0.50 | 50.0 | 100.0 |
| 19 | 47.5 | 0.0 | 2.0 | 0.0 | 0.50 | 0.00 | 50.0 | 100.0 |
| 20 | 29.5 | 0.0 | 2.0 | 0.0 | 0.50 | 0.00 | 68.0 | 100.0 |
| 21 | 24.5 | 0.0 | 2.0 | 0.0 | 0.50 | 0.00 | 73.0 | 100.0 |
| 22 | 47.0 | 0.0 | 2.0 | 0.0 | 1.00 | 0.00 | 50.0 | 100.0 |
| 23 | 29.0 | 0.0 | 2.0 | 0.0 | 1.00 | 0.00 | 68.0 | 100.0 |
| 24 | 24.0 | 0.0 | 2.0 | 0.0 | 1.00 | 0.00 | 73.0 | 100.0 |
| 25 | 48.0 | 0.0 | 1.0 | 0.0 | 1.00 | 0.00 | 50.0 | 100.0 |
| 26 | 30.0 | 0.0 | 1.0 | 0.0 | 1.00 | 0.00 | 68.0 | 100.0 |
| 27 | 25.0 | 0.0 | 1.0 | 0.0 | 1.00 | 0.00 | 73.0 | 100.0 |
| 28 | 47.5 | 0.0 | 0.0 | 2.0 | 0.50 | 0.00 | 50.0 | 100.0 |
| 29 | 29.5 | 0.0 | 0.0 | 2.0 | 0.50 | 0.00 | 68.0 | 100.0 |
| 30 | 24.5 | 0.0 | 0.0 | 2.0 | 0.50 | 0.00 | 73.0 | 100.0 |
| 31 | 47.0 | 0.0 | 0.0 | 2.0 | 1.00 | 0.00 | 50.0 | 100.0 |
| 32 | 29.0 | 0.0 | 0.0 | 2.0 | 1.00 | 0.00 | 68.0 | 100.0 |
| 33 | 24.0 | 0.0 | 0.0 | 2.0 | 1.00 | 0.00 | 73.0 | 100.0 |
| 34 | 48.0 | 0.0 | 0.0 | 1.0 | 1.00 | 0.00 | 50.0 | 100.0 |
| 35 | 30.0 | 0.0 | 0.0 | 1.0 | 1.00 | 0.00 | 68.0 | 100.0 |
| 36 | 25.0 | 0.0 | 0.0 | 1.0 | 1.00 | 0.00 | 73.0 | 100.0 |
| 37 | 46.5 | 1.0 | 2.0 | 0.0 | 0.50 | 0.00 | 50.0 | 100.0 |
| 38 | 28.5 | 1.0 | 2.0 | 0.0 | 0.50 | 0.00 | 68.0 | 100.0 |
| 39 | 23.5 | 1.0 | 2.0 | 0.0 | 0.50 | 0.00 | 73.0 | 100.0 |
| 40 | 46.0 | 1.0 | 2.0 | 0.0 | 1.00 | 0.00 | 50.0 | 100.0 |
| 41 | 28.0 | 1.0 | 2.0 | 0.0 | 1.00 | 0.00 | 68.0 | 100.0 |
| 42 | 23.0 | 1.0 | 2.0 | 0.0 | 1.00 | 0.00 | 73.0 | 100.0 |
| 43 | 47.0 | 1.0 | 1.0 | 0.0 | 1.00 | 0.00 | 50.0 | 100.0 |
| 44 | 29.0 | 1.0 | 1.0 | 0.0 | 1.00 | 0.00 | 68.0 | 100.0 |
| 45 | 24.0 | 1.0 | 1.0 | 0.0 | 1.00 | 0.00 | 73.0 | 100.0 |
| 46 | 46.5 | 1.0 | 0.0 | 2.0 | 0.50 | 0.00 | 50.0 | 100.0 |
| 47 | 28.5 | 1.0 | 0.0 | 2.0 | 0.50 | 0.00 | 68.0 | 100.0 |
| 48 | 23.5 | 1.0 | 0.0 | 2.0 | 0.50 | 0.00 | 73.0 | 100.0 |
| 49 | 46.0 | 1.0 | 0.0 | 2.0 | 1.00 | 0.00 | 50.0 | 100.0 |
| 50 | 28.0 | 1.0 | 0.0 | 2.0 | 1.00 | 0.00 | 68.0 | 100.0 |
| 51 | 23.0 | 1.0 | 0.0 | 2.0 | 1.00 | 0.00 | 73.0 | 100.0 |
| 52 | 47.0 | 1.0 | 0.0 | 1.0 | 1.00 | 0.00 | 50.0 | 100.0 |
| 53 | 29.0 | 1.0 | 0.0 | 1.0 | 1.00 | 0.00 | 68.0 | 100.0 |
| 54 | 24.0 | 1.0 | 0.0 | 1.0 | 1.00 | 0.00 | 73.0 | 100.0 |

### EMBODIMENTS OF THE DISCLOSURE

Embodiment 1. A highly concentrated particulate friction-reducing polymer slurry (HCPFRPS) composition comprising an oil-based carrier composition and a particulate friction-reducing polymer composition, wherein the oil-based carrier composition is present in an amount between about 50 wt. % and about 20 wt. % and the particulate friction-reducing polymer composition is present in an amount between about 50 wt. % and about 80 wt. %.

Embodiment 2. The Embodiment of Embodiment 1, wherein the HCPFRPS composition comprises: between about 45 wt. % and about 20 wt. % of the oil-based carrier composition and between about 55 wt. % and about 80 wt. % of the particulate friction-reducing polymer composition; between about 40 wt. % and about 20 wt. % of the oil-based carrier composition and between about 60 wt. % and about 80 wt. % of the particulate friction-reducing polymer composition; between about 35 wt. % and about 20 wt. % of the oil-based carrier composition and between about 65 wt. % and about 80 wt. % of the particulate friction-reducing polymer composition; between about 30 wt. % and about 20 wt. % of oil-based carrier composition and between about 70 wt. % and about 80 wt. % of the particulate friction-reducing polymer composition; or between about 25 wt. % and about 20 wt. % of the oil-based carrier composition and between about 75 wt. % and about 80 wt. % of the particulate friction-reducing polymer composition; and all subranges therein.

Embodiment 3. The Embodiment of Embodiment 1, wherein the oil-based carrier composition comprises one or more solvents, one or more suspending agents, one or more suspending aids, one or more viscosity modifiers, and one or more surfactants.

Embodiment 4. The Embodiment of Embodiment 3, wherein the oil-based carrier compositions comprises: between about 100.00 wt. % to about 80.00 wt. % of the one or more oil-based solvents, between about 0 wt. % to about 5 wt. % of the one or more suspending agents, between about 0 wt. % to about 5 wt. % of the one or more suspending aids, between about 0 wt. % to about 5 wt. % of the one or more viscosity modifiers, and between about 0 wt. % to about 5 wt. % of the one or more dispersing agents; between about 100.00 wt. % to about 84.00 wt. % of the one or more oil-based solvents, between about 0.01 wt. % to about 4 wt. % of the one or more suspending agents, between about 0.01 wt. % to about 4 wt. % of the one or more suspending aids, between about 0.01 wt. % to about 4 wt. % of the one or more viscosity modifiers, and between about 0.01 wt. % to about 4 wt. % of the one or more dispersing agents; between about 100.00 wt. % to about 88.00 wt. % of the one or more oil-based solvents, between about 0.01 wt. % to about 3 wt. % of the one or more suspending agents, between about 0.01 wt. % to about 3 wt. % of the one or more suspending aids, between about 0.01 wt. % to about 3 wt. % of the one or more viscosity modifiers, and between about 0.01 wt. % to about 3 wt. % of the one or more dispersing agents; between about 100.00 wt. % to about 92.00 wt. % of the one or more oil-based solvents, between about 0.01 wt. % to about 2 wt. % of the one or more suspending agents, between about 0.01 wt. % to about 2 wt. % of the one or more suspending aids, between about 0.01 wt. % to about 2 wt. % of the one or more viscosity modifiers, and between about 0.01 wt. % to about 2 wt. % of the one or more dispersing agents; or between about 100.00 wt. % to about 96.00 wt. % of the one or more oil-based solvents, between about 0.01 wt. % to about 1 wt. % of the one or more suspending agents, between about 0.01 wt. % to about 1 wt. % of the one or more suspending aids, between about 0.01 wt. % to about 1 wt. % of the one or more viscosity modifiers, and between about 0.01 wt. % to about 1 wt. % of the one or more dispersing agents; and all subranges therein.

Embodiment 5. The Embodiment of Embodiment 4, wherein the one or more oil-based solvents comprise one or more hydrocarbon solvents, one or more petroleum distillates, one or more mineral oils, one or more synthetic non-aqueous solvents, or any combination thereof; the one or more suspending agents comprise one or more organophilic clays, one or more diblock copolymers, one or more triblock copolymers, or any combination thereof; the one or more suspending aids comprising one or more diamide agents; and the one or more dispersing agents comprise one or more nonionic surfactants.

Embodiment 6. A downhole fluid composition comprising an effective amount of a highly concentrated particulate friction-reducing polymer slurry composition, a downhole base fluid, and one or more downhole fluid additives.

Embodiment 7. A drilling fluid composition comprising an effective amount of a highly concentrated particulate friction-reducing polymer slurry composition, a drilling base fluid, and one or more drilling fluid additives.

Embodiment 8. A treating fluid composition comprising an effective amount of a highly concentrated particulate friction-reducing polymer slurry composition, a treating base fluid, and one or more treating fluid additives.

Embodiment 9. A completion fluid composition comprising an effective amount of a highly concentrated particulate friction-reducing polymer slurry composition, a completion base fluid, and one or more completion fluid additives.

Embodiment 10. A zone isolation fluid composition comprising an effective amount of a highly concentrated particulate friction-reducing polymer slurry composition, a zone isolation base fluid, and one or more zone isolation fluid additives.

Embodiment 11. A method of making a highly concentrated particulate friction-reducing polymer slurry composition comprising adding with mixing one or more solvents, one or more polymeric suspending agents, one or more suspending aids, one or more viscosity modifiers, one or more surfactants, and one or more particulate friction-reducing polymers, according to an addition protocol and a mixing protocol.

Embodiment 12. A method of making a downhole fluid composition comprising adding with mixing an effective amount of a highly concentrated particulate friction-reducing polymer slurry composition, a downhole base fluid, and one or more downhole additives, according to an addition protocol and a mixing protocol.

Embodiment 13. A method of making a drilling fluid composition comprising adding with mixing an effective amount of a highly concentrated particulate friction-reducing polymer slurry composition, a drilling base fluid, and one or more drilling additives, according to an addition protocol and a mixing protocol.

Embodiment 14. A method of making a treating fluid composition comprising adding with mixing an effective amount of a highly concentrated particulate friction-reducing polymer slurry composition, a treating base fluid, and one or more treating additives, according to an addition protocol and a mixing protocol.

Embodiment 15. A method of making a completion fluid composition comprising adding with mixing an effective amount of a highly concentrated particulate friction-reducing polymer slurry composition, a completion base fluid, and one or more completion additives, according to an addition protocol and a mixing protocol.

Embodiment 16. A method of making a zone isolation fluid composition comprising adding with mixing an effective amount of a highly concentrated particulate friction-reducing polymer slurry composition, a zone isolation base fluid, and one or more zone isolation additives, according to an addition protocol and a mixing protocol.

Embodiment 17: The composition of Embodiment 1, wherein the particulate friction-reducing polymer composition comprises one or more acrylamide homopolymers, one or more acrylamide-containing polymers, or a mixture thereof. Embodiment 18: The composition of Embodiment 17, wherein the one or more acrylamide homopolymers are selected from anionic polyacrylamide (APAM) polymers of formula-(˜[CH2CH (CONH2)] m-[CH2CH (COOM)] n—)—wherein M is sodium, potassium, rubidium, and/or cesium, neutral polyacrylamide (PAM) polymers of formula-(CH2CH (CONH2)) m—, cationic polyacrylamide (CPAM) polymers of formula-(˜[CH2CH (CONH2)] m-[CH2CH (COORN+ (R′) 3Cl—)] n—)—, or any combination thereof.

Embodiment 19: The composition of Embodiment 17, wherein the one or more acrylamide-containing polymers are selected from zwitterionic acrylamide copolymers of acrylamide and 3-dimethyl (methacryloyloxyethyl) ammonium propane sulfonate (DMAPS), copolymers of acrylamide and vinyl alcohol, copolymers of acrylamide and 2-amino-2-methyl propane sulfonic acid (AMPS), copolymers of acrylamide and ethylene, copolymers of acrylamide and propylene, copolymers of acrylamide and acrylic acid, copolymers of acrylamide and methacrylic acid, copolymers of acrylamide and ethylenically unsaturated monomers, or any combination thereof.

Embodiment 20: The composition of Embodiment 1, wherein the HCPFRPS composition comprises: between about 45 wt. % and about 20 wt. % of the oil-based carrier composition and between about 55 wt. % and about 80 wt. % of the particulate friction-reducing polymer composition.

Embodiment 21: The composition of Embodiment 1, wherein the oil-based carrier composition comprises one or more solvents, one or more suspending agents, one or more suspending aids, one or more viscosity modifiers, and one or more surfactants.

Embodiment 22: The composition of Embodiment 21, wherein the oil-based carrier compositions comprises: between about 100 wt. % to about 80 wt. % of the one or more oil-based solvents, between about 0 wt. % to about 5 wt. % of the one or more suspending agents, between about 0 wt. % to about 5 wt. % of the one or more suspending aids, between about 0 wt. % to about 5 wt. % of the one or more viscosity modifiers, and between about 0 wt. % to about 5 wt. % of the one or more dispersing agents.

Embodiment 23: The composition of Embodiment 22, wherein the one or more oil-based solvents comprise one or more hydrocarbon solvents, one or more petroleum distillates, one or more mineral oils, one or more synthetic non-aqueous solvents, or any combination thereof.

Embodiment 24: The composition of Embodiment 22, wherein the one or more suspending agents comprise one or more organophilic clays, one or more diblock copolymers, one or more triblock copolymers, or any combination thereof.

Embodiment 25: The composition of Embodiment 22, wherein the one or more suspending aids comprise one or more diamide agents.

Embodiment 26: The composition of Embodiment 22, wherein the one or more dispersing agents comprise one or more nonionic surfactants.

Embodiment 27: The composition of Embodiment 1, wherein the particulate friction-reducing polymer composition comprises polymer particles having sizes or particle size distributions between about 250 microns and about 0.001 microns.

Embodiment 28: A downhole fluid composition comprising an effective amount of a highly concentrated particulate friction-reducing polymer slurry composition, a downhole base fluid, and one or more downhole fluid additives.

Embodiment 29: The downhole fluid composition of Embodiment 28, wherein: the downhole base fluid comprises a drilling base fluid and the one or more downhole fluid additives comprise one or more drilling fluid additives; the downhole base fluid comprises a treating base fluid, and the one or more downhole fluid additives comprise one or more treating fluid additives; the downhole base fluid comprises a completion base fluid, and the one or more downhole fluid additives comprise one or more completion fluid additives; the downhole base fluid comprises a zone isolation base fluid, and the one or more downhole fluid additives comprise one or more zone isolation fluid additives; or any combination thereof.

Embodiment 30: A method of making a highly concentrated particulate friction-reducing polymer slurry composition comprising adding with mixing one or more solvents, one or more polymeric suspending agents, one or more suspending aids, one or more viscosity modifiers, one or more surfactants, and one or more particulate friction-reducing polymers, according to an addition protocol and a mixing protocol.

Embodiment 31: A method of making a downhole fluid composition comprising adding with mixing an effective amount of a highly concentrated particulate friction-reducing polymer slurry composition, a downhole base fluid, and one or more downhole additives, according to an addition protocol and a mixing protocol.

Embodiment 32: The method of Embodiment 31, wherein: the downhole fluid composition is a drilling fluid composition, the downhole base fluid comprises drilling base fluid, and the one or more downhole fluid additives comprise one or more drilling additives; the downhole fluid composition is a treating fluid composition, the downhole base fluid comprises a treating base fluid, and the one or more downhole fluid additives comprise one or more treating additives; the downhole fluid composition is a completion fluid composition, the downhole base fluid comprises a completion base fluid, and the one or more downhole fluid additives comprise one or more completion additives; the downhole fluid composition is a zone isolation fluid composition, the downhole base fluid comprises a zone isolation base fluid, and the one or more downhole fluid additives comprise one or more zone isolation additives; or any combination thereof.

Embodiment 33: The method of Embodiment 32, wherein the one or more treating additives comprise a proppant.

Embodiment 34: The method of Embodiment 31, wherein the particulate friction-reducing polymer composition comprises one or more acrylamide homopolymers, one or more acrylamide-containing polymers, or a mixture thereof.

Embodiment 35: The method of Embodiment 31, wherein the particulate friction-reducing polymer composition comprises: between about 45 wt. % and about 20 wt. % of the oil-based carrier composition and between about 55 wt. % and about 80 wt. % of the particulate friction-reducing polymer composition.

Embodiment 36: The method of Embodiment 31, further comprising: making the particulate friction-reducing polymer slurry composition by adding with mixing one or more solvents, one or more polymeric suspending agents, one or more suspending aids, one or more viscosity modifiers, one or more surfactants, and one or more particulate friction-reducing polymers, according to an addition protocol and a mixing protocol.

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

What is claimed is:

1. A highly concentrated particulate friction-reducing polymer slurry (HCPFRPS) composition comprising an oil-based carrier composition and a particulate friction-reducing polymer composition, wherein the oil-based carrier composition is present in an amount between about 50 wt. % and about 20 wt. % and the particulate friction-reducing polymer composition is present in an amount between about 50 wt. % and about 80 wt. %.

2. The composition of claim 1, wherein the particulate friction-reducing polymer composition comprises one or more acrylamide homopolymers, one or more acrylamide-containing polymers, or a mixture thereof.

3. The composition of claim 2, wherein the one or more acrylamide homopolymers are selected from anionic polyacrylamide (APAM) polymers of formula —(—[CH2CH (CONH2)] m—[CH2CH (COOM)] n—)— wherein M is sodium, potassium, rubidium, and/or cesium, neutral polyacrylamide (PAM) polymers of formula-(CH2CH (CONH2)) m—, cationic polyacrylamide (CPAM) polymers of formula-(˜[CH2CH (CONH2)] m-[CH2CH (COORN+ (R′) 3Cl—)] n—)—, or any combination thereof.

4. The composition of claim 2, wherein the one or more acrylamide-containing polymers are selected from zwitterionic acrylamide copolymers of acrylamide and 3-dimethyl (methacryloyloxyethyl) ammonium propane sulfonate (DMAPS), copolymers of acrylamide and vinyl alcohol, copolymers of acrylamide and 2-amino-2-methyl propane sulfonic acid (AMPS), copolymers of acrylamide and ethylene, copolymers of acrylamide and propylene, copolymers of acrylamide and acrylic acid, copolymers of acrylamide and methacrylic acid, copolymers of acrylamide and ethylenically unsaturated monomers, or any combination thereof.

5. The composition of claim 1, wherein the HCPFRPS composition comprises: between about 45 wt. % and about 20 wt. % of the oil-based carrier composition and between about 55 wt. % and about 80 wt. % of the particulate friction-reducing polymer composition.

6. The composition of claim 1, wherein the oil-based carrier composition comprises one or more solvents, one or more suspending agents, one or more suspending aids, one or more viscosity modifiers, and one or more surfactants.

7. The composition of claim 6, wherein the oil-based carrier compositions comprises: between about 100 wt. % to about 80 wt. % of the one or more oil-based solvents, between about 0 wt. % to about 5 wt. % of the one or more suspending agents, between about 0 wt. % to about 5 wt. % of the one or more suspending aids, between about 0 wt. % to about 5 wt. % of the one or more viscosity modifiers, and between about 0 wt. % to about 5 wt. % of the one or more dispersing agents.

8. The composition of claim 7, wherein the one or more oil-based solvents comprise one or more hydrocarbon solvents, one or more petroleum distillates, one or more mineral oils, one or more synthetic non-aqueous solvents, or any combination thereof.

9. The composition of claim 7, wherein the one or more suspending agents comprise one or more organophilic clays, one or more diblock copolymers, one or more triblock copolymers, or any combination thereof.

10. The composition of claim 7, wherein the one or more suspending aids comprise one or more diamide agents.

11. The composition of claim 7, wherein the one or more dispersing agents comprise one or more nonionic surfactants.

12. The composition of claim 1, wherein the particulate friction-reducing polymer composition comprises polymer particles having sizes or particle size distributions between about 250 microns and about 0.001 microns.

13. A downhole fluid composition comprising an effective amount of a highly concentrated particulate friction-reducing polymer slurry composition, a downhole base fluid, and one or more downhole fluid additives.

14. The downhole fluid composition of claim 13, wherein:
the downhole base fluid comprises a drilling base fluid and the one or more downhole fluid additives comprise one or more drilling fluid additives;
the downhole base fluid comprises a treating base fluid, and the one or more downhole fluid additives comprise one or more treating fluid additives;
the downhole base fluid comprises a completion base fluid, and the one or more downhole fluid additives comprise one or more completion fluid additives;
the downhole base fluid comprises a zone isolation base fluid, and the one or more downhole fluid additives comprise one or more zone isolation fluid additives; or
any combination thereof.

15. A method of making a downhole fluid composition comprising adding with mixing an effective amount of a highly concentrated particulate friction-reducing polymer slurry composition, a downhole base fluid, and one or more downhole additives, according to an addition protocol and a mixing protocol.

16. The method of claim 15, wherein the particulate friction-reducing polymer composition comprises one or more acrylamide homopolymers, one or more acrylamide-containing polymers, or a mixture thereof.

17. The method of claim 15, wherein the particulate friction-reducing polymer composition comprises: between about 45 wt. % and about 20 wt. % of the oil-based carrier composition and between about 55 wt. % and about 80 wt. % of the particulate friction-reducing polymer composition.

18. The method of claim 15, wherein:
the downhole fluid composition is a drilling fluid composition, the downhole base fluid comprises drilling base fluid, and the one or more downhole fluid additives comprise one or more drilling additives;
the downhole fluid composition is a treating fluid composition, the downhole base fluid comprises a treating base fluid, and the one or more downhole fluid additives comprise one or more treating additives;
the downhole fluid composition is a completion fluid composition, the downhole base fluid comprises a completion base fluid, and the one or more downhole fluid additives comprise one or more completion additives;
the downhole fluid composition is a zone isolation fluid composition, the downhole base fluid comprises a zone isolation base fluid, and the one or more downhole fluid additives comprise one or more zone isolation additives;
or any combination thereof.

19. The method of claim 18, wherein the one or more treating additives comprise a proppant.

20. The method of claim 16, further comprising:
making the particulate friction-reducing polymer slurry composition by adding with mixing one or more solvents, one or more polymeric suspending agents, one or more suspending aids, one or more viscosity modifiers, one or more surfactants, and one or more particulate friction-reducing polymers, according to an addition protocol and a mixing protocol.
